(19) United States
(12) Patent Application Publication
(10) Pub. No.: US 2016/0160714 A1
(43) Pub. Date: Jun. 9, 2016

(54) GAS TURBINE ENGINE WITH SPLIT LUBRICATION SYSTEM

(71) Applicant: UNITED TECHNOLOGIES CORPORATION, Hartford, CT (US)

(72) Inventor: Denman H. James, Windsor, CT (US)

(21) Appl. No.: 14/908,561

(22) PCT Filed: Aug. 14, 2014
(86) PCT No.: PCT/US14/50981

§ 371 Date: Jan. 29, 2016

Related U.S. Application Data
(60) Provisional application No. 61/882,651, filed on Sep. 26, 2013.

(51) Int. Cl. F01M 1/02; F02C 7/06; F01M 11/04

(52) U.S. Cl. CPC F01M 1/02; F01M 11/045; F02C 7/06; F01M 2001/0253

(57) ABSTRACT

A lubrication system for use in a gas turbine engine is comprised of a first pump driven by a first shaft at a first speed and a second pump driven by a second shaft at a second speed that is faster than the first speed. The first and second pumps provide lubricant to an engine operating system. The pumps are optimized based on differential speed changes between the two drive speeds for the respective shafts to provide an optimized oil flow for the engine as a whole. A gas turbine engine and a method of operating a gas turbine engine are also disclosed.

### CROSS-REFERENCE TO RELATED APPLICATION

This application claims priority to U.S. Provisional Application No. 61/882,651, filed Sep. 26, 2013.

### BACKGROUND

This application relates to a lubrication system that uses a two pump configuration to optimize lubricant delivery in a gas turbine engine.

Gas turbine engines include engine oil pump systems that have generally been powered by an accessory gearbox. Typically, the accessory gearbox is driven by a high rotor, i.e., high speed shaft, of the gas turbine engine. A typical oil pump system includes an oil supply tank, a supply pump, and a scavenging pump that returns scavenged oil to the supply tank. The oil supply pump is generally sized to meet maximum flow conditions, and all remaining operating points then receive whatever flow the system provides at the “off design” condition. This results in excessive oil flow at many operating points. Excessive oil flow causes churning and pumping of the oil, which contribute to engine parasitic losses.

In certain system configurations, valves have been used in an attempt to divert the excess oil flow back to the supply tank. Another proposed solution to address excess oil flow is the use of a variable displacement oil pump. These configurations are not desirable due to cost and weight trade-off issues.

### SUMMARY

In a featured embodiment, a lubrication system for use in a gas turbine engine has a first engine shaft configured to rotate at a first speed. A second engine shaft is configured to rotate at a second speed that is faster than the first speed. A first pump is configured to be driven by the first shaft. A second pump is configured to be driven by the second shaft. The first and second pumps provide lubricant to an engine operating system. Capacities of the first and second pumps are optimized to minimize an amount of lubricant supplied to the engine operating system based on the associated first and second speeds.

In another embodiment according to the previous embodiment, a lubricant supply tank provides lubricant to both the first and second pumps.

In another embodiment according to any of the previous embodiments, the lubricant is oil.

In another embodiment according to any of the previous embodiments, at least one scavenge pump returns scavenged lubricant from the engine operating system to the supply tank.

In another embodiment according to any of the previous embodiments, the at least one scavenge pump is driven by the first engine shaft.

In another embodiment according to any of the previous embodiments, the at least one scavenge pump is driven by the second engine shaft.

In another embodiment according to any of the previous embodiments, the at least one scavenge pump has at least a first scavenge pump driven by the first engine shaft and a second scavenge pump driven by the second engine shaft.

In another embodiment according to any of the previous embodiments, the first and second pumps are non-variable pumps that operate without a control system.

In another embodiment according to any of the previous embodiments, a control system monitors engine operating conditions for lubrication requirements as a function of mechanical speed and calculated loads, and controls the first and/or second pumps to optimize the amount of lubricant supplied to the engine operating system based on the engine operating condition.

In another featured embodiment, a gas turbine engine has a low shaft that interconnects a fan, a low pressure compressor, and a low pressure turbine. A high shaft interconnects a high pressure compressor and high pressure turbine. A combustor is arranged between the high pressure compressor and the high pressure turbine. A first pump is configured to be driven by the low shaft. A second pump is configured to be driven by the high shaft. The first and second pumps provide lubricant to an engine operating system. Capacities of the first and second pumps are optimized to minimize an amount of lubricant supplied to the engine operating system based on the associated first and second speeds.

In another embodiment according to previous embodiment, the low shaft is connected to the fan through a geared architecture.

In another embodiment according to any of the previous embodiments, a lubricant supply tank provides lubricant to both the first and second pumps.

In another embodiment according to any of the previous embodiments, the lubricant is oil.

In another embodiment according to any of the previous embodiments, at least one scavenge pump returns scavenged lubricant from the engine operating system to the supply tank.

In another embodiment according to any of the previous embodiments, the at least one scavenge pump is driven by the low or high shaft.

In another embodiment according to any of the previous embodiments, the at least one scavenge pump has at least a first scavenge pump driven by the low shaft and a second scavenge pump driven by the high shaft.

In another embodiment according to any of the previous embodiments, a control system monitors engine operating conditions for lubrication requirements as a function of mechanical speed and calculated loads, and controls the first and/or second pumps to optimize the amount of lubricant supplied to the engine operating system based on the engine operating condition.

In another embodiment according to any of the previous embodiments, a method for operating a lubrication system in a gas turbine engine includes the steps of providing a first engine shaft configured to rotate at a first speed, a second engine shaft configured to rotate at a second speed that is faster than the first speed. A first pump is configured to be driven by the first shaft, and a second pump is configured to be driven by the second shaft. Lubricant is delivered to an engine operating system via the first and second pumps by optimizing capacities of the first and second pumps to minimize an amount of lubricant supplied to the engine operating system based on the associated first and second speeds.

The foregoing features and elements may be combined in any combination without exclusivity, unless expressly indicated otherwise. These and other features may be best understood from the following drawings and specification.

### BRIEF DESCRIPTION OF THE DRAWINGS

FIG. 1 schematically shows a gas turbine engine.

FIG. 2 shows a schematic diagram of a lubrication system as used in the engine of FIG. 1.

FIG. 3 shows a graph of delivered oil flow (pounds per minute) vs. required oil flow (pounds per minute).

### DETAILED DESCRIPTION

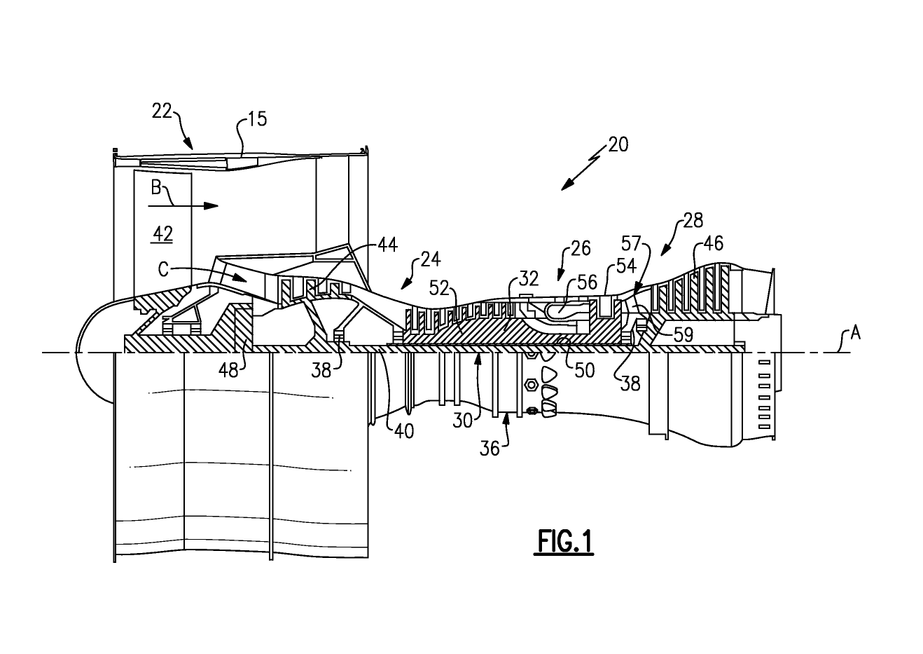

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of 1 bm of fuel being burned divided by 1 bf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second.

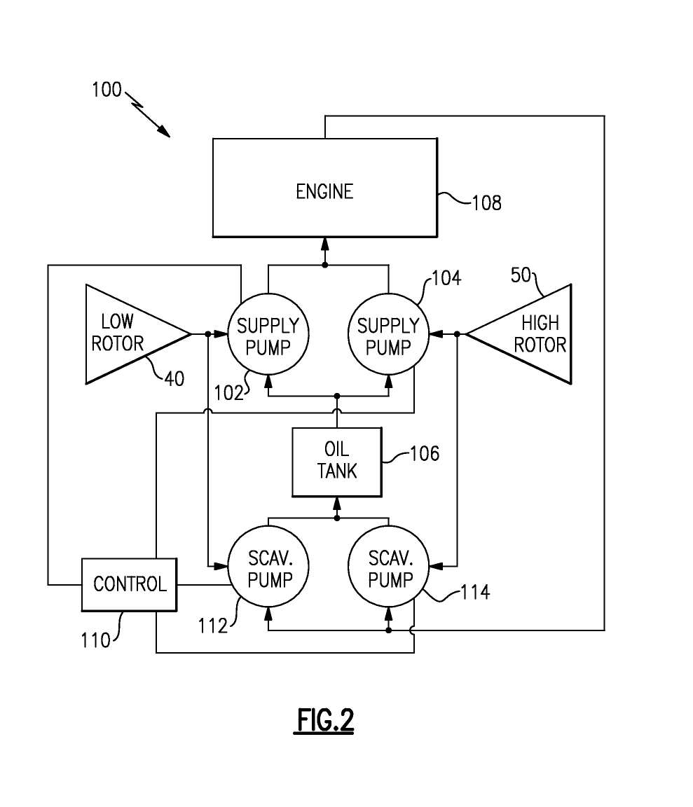

In the example shown in FIG. 2, a lubrication system 100 for the gas turbine engine 20 includes a first supply pump 102, a second supply pump 104, and a lubricant supply tank 106. In one example, the lubricant comprises oil; however, other types of lubricant can also be used. The lubricant supply tank 106 supplies lubricant to the first and second supply pumps 102, 104.

The first supply pump 102 is driven by the low rotor/low shaft 40 and the second supply pump 104 is driven by the high rotor/high shaft 50. As discussed above, the low shaft 40 rotates at a slower speed than the high shaft 50. The first 102 and second 104 supply pumps provide lubrication to an engine operating system 108. The speeds of the low and high rotors are driven by a thermodynamic cycle and the “matching” between the two spools. Thus, the rotor speeds, while coupled, vary over a flight envelope and a ratio between the two speeds changes as a function of flight condition (altitude, throttle setting, day type, etc). Capacities of the first and second pumps are optimized to minimize the amount of lubricant supplied to the engine operating system.

In one example, an optional control system 110 monitors engine operating conditions for lubrication requirements which may be a function of mechanical speed and calculated loads, and controls the first 102 and/or second 104 pumps to optimize an amount of lubricant supplied to the engine operating system 108 based on the engine operating condition. In other words, the optional embodiment that includes the control system 110 identifies the current operating condition and then controls the first 102 and/or second 104 pumps to supply the optimal amount of lubricant for that identified operating condition. For example, if the engine operating condition is a low speed condition, only the low speed pump, that is, the first supply pump 102, may be needed to supply the desired amount of lubrication. Thus, the system 100 provides a better match of engine lubricant flow requirements with a delivered amount of lubricant to reduce engine parasitic losses previously caused by pumping and churning of an excessive amount of supplied lubricant.

First 112 and second 114 scavenging pumps return lubricant from the engine operating system 108 to the supply tank 106. The first scavenging pump 112 is driven by the low shaft 40 and the second scavenging pump 114 is driven by the high shaft 50. The control system 110, when included in an optional embodiment, may also control operation of the first 112 and/or second 114 scavenging pumps.

As discussed above, the system 100 uses two supply pumps 102, 104, one driven by the low shaft 40 and one drive by the high shaft 50. The pump sizes can be selected through a mathematical optimization process to minimize the overall engine lubricant flow in excess to requirements, or with the objective of minimizing pump size. This results in a configuration that utilizes the inherent speed differences between the shafts 40, 50 at different operating points, as determined by engine cycle selection, to minimize the excess lubricant delivery to the engine. The use of these pumps, which deliver flow proportionally to their rotational speed, will then allow optimization of the total delivered capacity given the two drive rotor lapse rates.

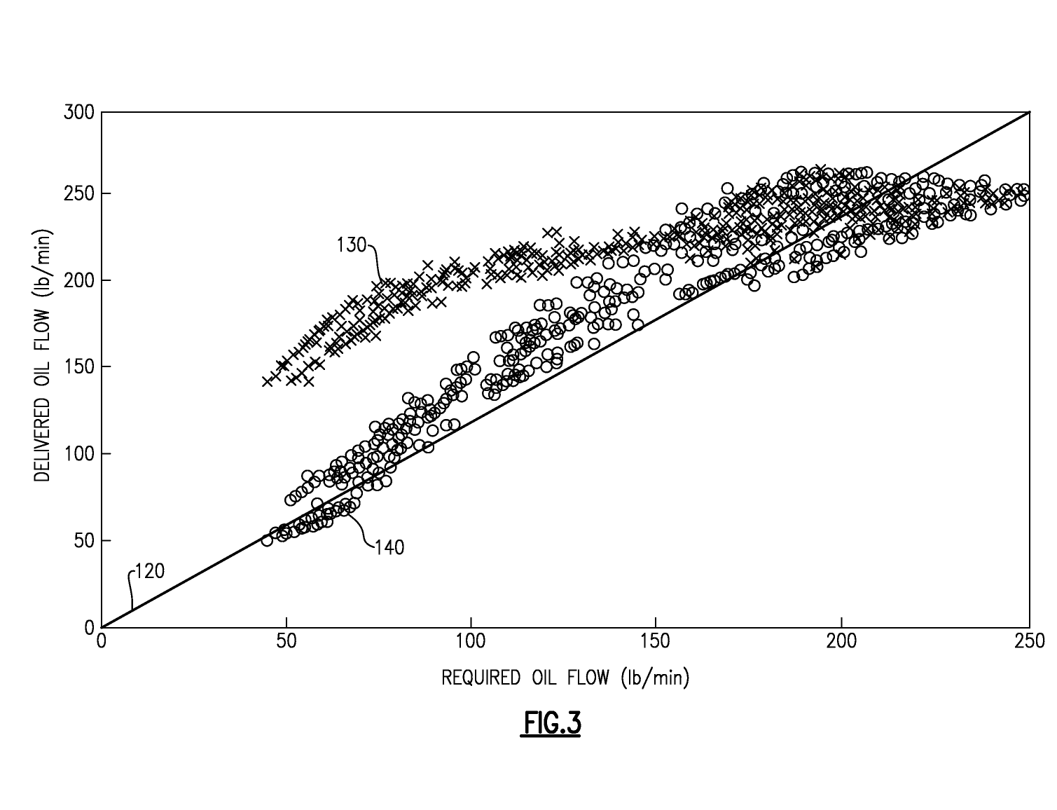

FIG. 3 shows an example of delivered oil flow (pounds per minute) vs. required oil flow (pounds per minute). The ideal flow line is identified at 120. The area identified at 130 shows a single pump configuration where the single pump is driven by the high shaft 50. The area identified at 140 shows the two pump system, i.e. a split system, which optimizes lubricant delivery by using a first supply pump 102 driven by the low shaft 40 and a second supply pump 104 driven by the high shaft 50. As shown, the spilt system provides a flow that closely matches the ideal flow line 120.

Thus, the benefits of this split, i.e. two pump, system in conjunction with optimized lubricant delivery, are reduced pump size and weight, as well as reduced engine parasitic power extraction. The inherent differences in shaft speed are used to provide an optimized lubricant flow without the weight and cost of a variable capacity pump. This system, in the configuration without the additional control system provides the significant benefit of a variable speed pump placed on a single drive shaft with two fixed capacity pumps operating on separate shafts without the weight, complexity and cost of a controlled system and/or variable capacity pumps.

Although an embodiment of this invention has been disclosed, a worker of ordinary skill in this art would recognize that certain modifications would come within the scope of this disclosure. For that reason, the following claims should be studied to determine the true scope and content of this disclosure.

1. A lubrication system for use in a gas turbine engine comprising:
a first engine shaft configured to rotate at a first speed;
a second engine shaft configured to rotate at a second speed that is faster than the first speed;
a first pump configured to be driven by the first shaft;
a second pump configured to be driven by the second shaft, the first and second pumps providing lubricant to an engine operating system; and
wherein capacities of the first and second pumps are optimized to minimize an amount of lubricant supplied to the engine operating system based on the associated first and second speeds.

2. The lubrication system according to claim 1 including a lubricant supply tank that provides lubricant to both the first and second pumps.

3. The lubrication system according to claim 2 wherein the lubricant is oil.

4. The lubrication system according to claim 2 including at least one scavenge pump that returns scavenged lubricant from the engine operating system to the supply tank.

5. The lubrication system according to claim 4 wherein the at least one scavenge pump is driven by the first engine shaft.

6. The lubrication system according to claim 4 wherein the at least one scavenge pump is driven by the second engine shaft.

7. The lubrication system according to claim 4 wherein the at least one scavenge pump comprises at least a first scavenge pump driven by the first engine shaft and a second scavenge pump driven by the second engine shaft.

8. The lubrication system according to claim 1 wherein the first and second pumps are non-variable pumps that operate without a control system.

9. The lubrication system according to claim 1 including a control system that monitors engine operating conditions for lubrication requirements as a function of mechanical speed and calculated loads, and controls the first and/or second pumps to optimize the amount of lubricant supplied to the engine operating system based on the engine operating condition.

10. A gas turbine engine comprising:
a low shaft that interconnects a fan, a low pressure compressor, and a low pressure turbine;
a high shaft that interconnects a high pressure compressor and high pressure turbine;
a combustor arranged between the high pressure compressor and the high pressure turbine;
a first pump configured to be driven by the low shaft;
a second pump configured to be driven by the high shaft, the first and second pumps providing lubricant to an engine operating system; and
wherein capacities of the first and second pumps are optimized to minimize an amount of lubricant supplied to the engine operating system based on the associated first and second speeds.

11. The gas turbine engine according to claim 10 wherein the low shaft is connected to the fan through a geared architecture.

12. The gas turbine engine according to claim 10 including a lubricant supply tank that provides lubricant to both the first and second pumps.

13. The gas turbine engine according to claim 12 wherein the lubricant is oil.

14. The gas turbine engine according to claim 12 including at least one scavenge pump that returns scavenged lubricant from the engine operating system to the supply tank.

15. The gas turbine engine according to claim 14 wherein the at least one scavenge pump is driven by the low or high shaft.

16. The gas turbine engine according to claim 14 wherein the at least one scavenge pump comprises at least a first scavenge pump driven by the low shaft and a second scavenge pump driven by the high shaft.

17. The gas turbine engine according to claim 10 including a control system that monitors engine operating conditions for lubrication requirements as a function of mechanical speed and calculated loads, and controls the first and/or second pumps to optimize the amount of lubricant supplied to the engine operating system based on the engine operating condition.

18. A method for operating a lubrication system in a gas turbine engine comprising the steps of:
providing a first engine shaft configured to rotate at a first speed, a second engine shaft configured to rotate at a second speed that is faster than the first speed, a first pump configured to be driven by the first shaft, and a second pump configured to be driven by the second shaft; and
delivering lubricant to an engine operating system via the first and second pumps providing by optimizing capacities of the first and second pumps to minimize an amount of lubricant supplied to the engine operating system based on the associated first and second speeds.
